(19) United States
(12) Patent Application Publication
(10) Pub. No.: US 2019/0306170 A1
(43) Pub. Date: Oct. 3, 2019

(54) SYSTEMS AND METHODS FOR ADAPTIVE DATA COLLECTION USING ANALYTICS AGENTS

(71) Applicants: Yanlin Wang, Cupertino, CA (US); Weizhi Li, San Jose, CA (US)

(72) Inventors: Yanlin Wang, Cupertino, CA (US); Weizhi Li, San Jose, CA (US)

(21) Appl. No.: 15/940,967

(22) Filed: Mar. 30, 2018

(51) Int. Cl. H04L 29/06; G06F 21/55; H04L 29/08; G06F 21/60

(52) U.S. Cl. CPC H04L 63/102; G06F 21/552; G06F 21/604; H04L 63/20; H04L 67/22

(57) ABSTRACT

Systems and methods for adaptive data collection using analytics agents for privileged access management. Embodiments of the invention deploy analytics agents to computer clients and servers at enterprise premises. Analytics agents collect event and contextual data of privileged users, record their computer access activities, and report the collected data to servers of analytics services. Analytics services produce entity behavior models and agent rules, and instruct analytics agents for adaptive data collection and session recording and uploading to the cloud storage. In an embodiment, an analytics agent is able to adjust the data collection scope dynamically and determine the session recording and uploading actions based on event entity behavior models and configured agent rules. Agent rules are automatically pushed to an analytics agent from analytics services and also can be set manually by system administrators.

### FIELD OF THE DISCLOSURE

This disclosure relates generally to Internet security and, more particularly, to systems and methods for adaptive data collection using analytics agents for privileged access management.

### BACKGROUND

In computer systems, users are granted with different levels of access permission to use computers resources (e.g., creating new files, executing a system command, running a software application). A privileged user is one who has administrative access right to computer systems. For instance, a privileged user can change system configurations, install software, change user accounts or access secure data.

From a security perspective, even the access by a trusted privileged user needs to be controlled and monitored. Commands executed by a privileged user (e.g., a “sudo” user) with or without intention may make critical system impact, e.g., permanently removing a system log file. Security systems typically record all the computer access activities of privileged users to make sure not missing any information that may be needed for auditing purpose in the future. When system audit is enabled by a system administrator, event data that logs a privileged user's computer access activity (e.g., time and session duration that a user logs on to a database server) as well as contextual data that is associated the privileged user (e.g., user role type) are collected. This creates excessive log data that requires a large amount of data storage space locally as well as in cloud.

### SUMMARY OF THE INVENTION

Embodiments of the invention deploy analytics agents to computer clients and servers at enterprise premises. In an embodiment, an analytics agent collects event and contextual data of privileged users, record their computer access activities, and report the collected data to servers of analytics services. Analytics services produce entity behavior models and agent rules based on the received event reports from analytics agents, and instruct analytics agents for adaptive data collection and session recording and/or uploading to the cloud storage.

In an embodiment, an analytics agent is able to adjust the data collection scope based on the configured agent rules. Agent rules are automatically pushed to an analytics agent from servers of analytics services and also can be set manually by system administrators.

In an embodiment, the risk level of an entity such as a user, a server, and an application is evaluated by matching the entity to a risky entity bloom filter implemented in the analytics agent. If there is a match, i.e., the event entity or the event entity's behavior is considered as critical or risky, an agent rule configured in the analytics agent then triggers an action of collecting more data as addendum. The addendum data to be collected can be, for example, additional contextual data such as the user role type associated with the event entity, and Centrify Zone data associated event entity, etc. The addendum data enriches the event and contextual data associated with the event and the event entity. As a result, analytics services can refine the entity behavior models using the enriched event and contextual data and improve the privileged threat detection accuracy.

In an embodiment, an agent rule evaluates any event condition such as if an event is a privilege elevation event, e.g., executing “dzdo”, a Centrify-enhanced “sudo” command. In such a privilege elevation event, the agent rule typically triggers actions of collecting more data as addendum.

In an embodiment, in the context of behavior risk analytics, an analytics agent is able to change the data collection scope adaptively based on the collective risk of an event or a set of user behavior events as well as the instruction from analytics services. For example, when analytics services detect the risk of an event or a set of events, the analytics services will instruct the analytics agent to collect more data as addendum for enriching a risky behavior event, for example:

(1) addendum of session recording data, i.e., starting to record on-going sessions;

(2) addendum of contextual data, e.g. current Centrify Zone data for a specific event user or event server;

(3) addendum of auditing data. Usually auditing data has too much of details, e.g. system calls, network and file usage. By default, collection of audit data is disabled.

In an embodiment, when analytics services detect a threat, or an anomaly event during a session on a machine at an enterprise premise, analytics services send an agent command to the analytics agent on the machine, which then collects and uploads the recorded session data to the cloud storage. Instead of collecting and uploading all the recorded session data to the cloud storage, selectively collecting and uploading the recorded session data associated with an anomaly event reduces the cost of the cloud storage and also speed up the process of searching and auditing stored recorded session data.

In an embodiment, analytics services produce entity risk profiles such as server risk, application risk, user risk, and command risk based on received event reports and contextual data associated with an entity. Analytics services store these risk profiles of risky entities in the form of risky entity bloom filter and synchronizes them with analytics agents. An analytics agent applies agent rules and the risky entity bloom filter over the received events, and determines the corresponding actions. For example, when an event privilege elevation happens on a risky server with a risky command, the predefined agent rule triggers the actions of data addendum collection, and/or session data recording and uploading to cloud if the event entity matches the risky entity bloom filter.

In an embodiment, a risky entity filter contains a list of entities that are evaluated as risky entities by analytic services. Each entity in the risky entity filter is associated with two attributes, entity type and risk level. The type of an entity in the risky entity filter can be an application, a server, a user, a command, etc. The risk level of an entity in the risky entity filter can be low, medium, and high, which is evaluated by analytic services based on the entity's behaviors in the past.

In an embodiment, the risky entity filter in servers of analytics services are synchronized with the risky entity filters in analytics agents.

In an embodiment, a system administrator can write agent rules in an analytics agent to trigger collecting and uploading the recorded session data if an ongoing event is associated with a risky server, command, user, or application, etc.

In an embodiment, a system administrator can also write ad-hoc rules to trigger when an analytics agent should upload the recorded session data. Each uploaded session recording will be associated with the event that triggers it.

### BRIEF DESCRIPTION OF DRAWINGS

Embodiments of the invention are illustrated by way of example and not by way of limitation in the figures of the accompanying drawings in which like references indicate similar elements. Note that references to “an” or “one” embodiment in this disclosure are not necessarily to the same embodiment, and such references mean “at least one.”

FIG. 1 is a block diagram that shows the components of an embodiment of the invention as they exist in a computer network, or other computing environment where analytics agents are deployed at enterprise premises, and interact with analytic services for privileged threat detection and remediation.

FIG. 2 is a block diagram that shows the components of an analytics agent. An analytics agent collects event and contextual data of privileged users from various data sources, transforms and reports the collected data to analytics services. In addition, an analytics agent determines corresponding actions based on the collected event data, configured agent rules and risky entity bloom filters.

FIG. 3 is a block diagram that shows the components of analytics services. An analytic data process engine in analytics services produces contextual data models including zone model, active directory (AD) model and other contextual data model based on received contextual data. An identity behavior analysis engine evaluates the risk levels of received events, which are used by a rule engine to produce entity behavior models as well as agent rules. The risky entity bloom filter, which is derived from entity behavior models, and agent rules are pushed to analytic agents as runtime evaluation data set and runtime instructions to achieve dynamic actions such as adaptive data collection, and adaptive session recording collection and uploading to the cloud storage.

### DETAILED DESCRIPTION OF THE INVENTION

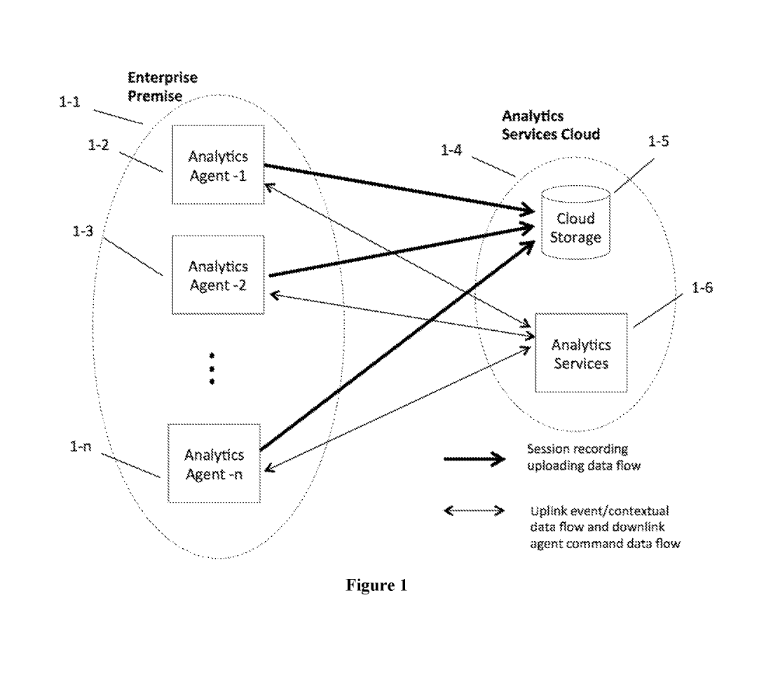

FIG. 1 is a block diagram that shows the components of an embodiment of the invention as they exist in a computer network, or other computing environment. Analytics agents, 1-2, 1-3, . . . , 1-n, are deployed at an enterprise premise 1-1 and interact with Analytic Services 1-6 and Cloud Storage 1-5 at Analytics Services Cloud 1-4 for privileged threat detection and remediation.

In an embodiment, Analytics Agents, 1-2, 1-3, . . . , 1-n, collect and report events on machines in an Enterprise Premise 1-1. Analytic Services 1-6 apply well known machine learning algorithms (e.g., clustering algorithm) to build event entity behavior models and detect anomalies based on the received event reports from one or more Analytics Agents. Once an anomaly is detected, Analytic Services 1-6 send an agent command to the Analytics Agent where the anomaly is detected. Based on the received agent command and pre-configured agent rules, the Analytics Agent may collect more addendum data and/or upload recorded session data to the Cloud Storage 1-5. In parallel, the entity behavior models at Analytic Services 1-6 are updated and refined iteratively based on incoming event data streams and synchronized with risky entity filters at Analytics Agents.

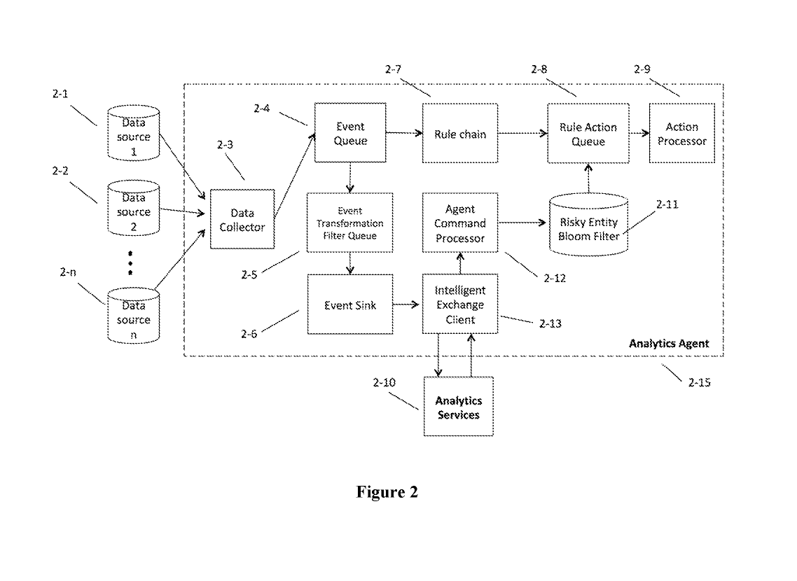

FIG. 2 is a block diagram that shows the components of an analytics agent 2-15. The analytics agent 2-15 collects event and contextual data of privileged users from various data sources, transforms and reports the collected data to analytics service 2-10. In addition, the analytics agent 2-15 determines corresponding actions based on the collected event data, configured agent rules, received agent commands from Analytics Service 1-6 and risky entity bloom filters 2-11.

In an embodiment, a data collector 2-3 retrieves event and contextual data from various data sources such as data source 1 (2-1), data source 2 (2-2), and data source n (2-n). The event data log a user's computer access activity (e.g., time and session duration that a user logs on to a database server) while the contextual data is associated a user (e.g., user role type). These data sources are system logs that reside on machines at enterprise premises, e.g., Windows event logs, Linux Syslog, Centrify Syslog, Centrify Zone data, etc.

In an embodiment, collected event and contextual data is put into an Event Queue 2-4, and then copied to an Event Transformation Filter Queue 2-5, where the event and contextual data is normalized and formatted. An Event Sink 2-6 receives the normalized and formatted data, which is then reported to Analytics Services 2-10 by an Intelligent Exchange Client 2-13.

In an embodiment, collected event and contextual data is run through Rule Chain 2-7 in parallel, which contains agent rules pushed from the Analytics Services 2-10 or set by system administrators. Based on the agent rules in the Rule Chain 2-7 and event entity behavior models in Risky Entity Bloom Filter 2-11, actions such as starting session recording, collecting more data as addendum, or uploading recorded session data to the cloud storage are queued at Rule Action Queue 2-8, and finally processed by Action Processor 2-9 for action execution.

In an embodiment, the Risky Entity Bloom Filter 2-11 is updated based on the agent command received by the Agent Command Processor 2-12. An agent command may instruct the agent to update the Risky Entity Bloom Filter 2-11, which is derived from entity behavior models produced by Analytics Services 2-10.

In an embodiment, the Risky Entity Bloom Filter 2-11 contains the set of risky entities that is identified by Analytics Services 2-10. These risky entities represent the risky entities such as computer, network device, application, command that may have risk to cause critical system impact. Analytics Services 2-10 continuously update the risky entity bloom filter, which is derived by the entity behavior models based on the received event and contextual data, and synchronize with the Risky Entity Bloom Filter 2-11 at analytics agent 2-15. Together with agent rules, each event will be evaluated against the Risky Entity Bloom Filter 2-11 to determine if the entities associated with the event is risky or may cause critical system impact. If so, actions need to be taken to enrich the event data, e.g., starting session recording, collecting more data as addendum, or uploading recorded session data to the cloud storage.

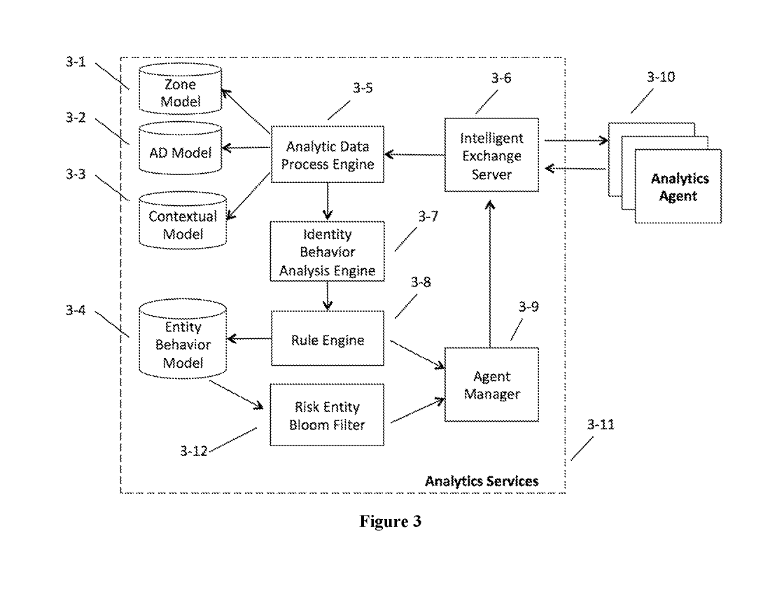

FIG. 3 is a block diagram that shows the components of analytics services. An Intelligent Exchange Server 3-6 is the interface of Analytics Services to an Analytics Agent 3-10. The Intelligent Exchange Server 3-6 receives event data from one or more Analytics Agents 3-10 and sends agent commands to one or more Analytics Agents 3-10.

In an embodiment, an analytic data process engine 3-5 in analytics services 3-11 produces contextual data models including zone model 3-1, AD model 3-2 and contextual model 3-3 based on received contextual data. The analytic data process engine 3-5 filters out data, which is irrelevant to user/entity behavior analysis, and forwards only the user/entity behavior event data to an identity behavior analysis engine 3-7.

In an embodiment, the identity behavior analysis engine 3-7 evaluates the risk levels of events, which are then used by a rule engine 3-8 to produce entity behavior models 3-4 as well as agent rules.

In an embodiment, the risky entity bloom filter 3-12, which is derived from entity behavior models 3-4, at analytics services 3-11 are synchronized with the Risky Entity Bloom Filter 2-11 at the Analytics Agent 3-10.

In an embodiment, the risky entity bloom filter 3-12 and the agent rules are pushed via Agent Manager 3-9 to analytic agents for adaptive data collection, and adaptive session recording and uploading.

What is claimed is:

1. A method for managing data in a privileged access management computer system, the method comprising:
collecting, at an analytics agent, event data associated with an entity, wherein the event data records computer system access activities of the entity;
reporting the event data to an analytics server, wherein the analytics server produces an entity behavior model associated with the entity based on the event data;
receiving a risky entity bloom filter derived from the entity behavior model associated with the entity, wherein the risky entity bloom filter indicates a risk level of the entity;
receiving agent rules for event data collection, wherein the agent rules define actions based on the risk level of the entity;
determining actions of event data collection based on the risk level of the entity and the agent rules.

2. The method of claim 1, wherein said actions include one of the following actions:
collecting contextual data as an addendum to the event data;
collecting session recording of computer system access activities of the entity;
uploading the session recording of the entity to a cloud storage.

3. The method of claim 1, wherein said risky entity bloom filter contains a list of risky entities with different levels of risk;

4. The method of claim 1, wherein said entity behavior model describes patterns of said computer system access activities by said entity.

5. A system for managing data collection in a privileged access management computer system comprising:
one or more computers; and
a computer-readable medium coupled to said one or more computers having instructions stored thereon which, when executed by said one or more computers, cause said one or more computers to perform operations comprising:
collecting, at an analytics agent, event data associated with an entity, wherein the event data records computer system access activities of the entity;
reporting the event data to an analytics server, wherein the analytics server produces an entity behavior model associated with the entity based on the event data;
receiving a risky entity bloom filter derived from the entity behavior model associated with the entity, wherein the risky entity bloom filter indicates a risk level of the entity;
receiving agent rules for event data collection, wherein the agent rules define actions based on the risk level of the entity;
determining actions of event data collection based on the risk level of the entity and the agent rules.

6. The system of claim 5, wherein said actions include one of the following actions:
collecting contextual data as an addendum to the event data;
collecting session recording of computer system access activities of the entity;
uploading the session recording of the entity to a cloud storage.

7. The system of claim 5, wherein said risky entity bloom filter contains a list of risky entities with different levels of risk.

8. The method of claim 5, wherein said entity behavior model describes patterns of said computer system access activities by said entity.
